(19) United States
(12) Patent Application Publication
(10) Pub. No.: US 2005/0127127 A1
(43) Pub. Date: Jun. 16, 2005

(54) Safety switch of screwdriver

(76) Inventor: Wen-Sheng Huang, Taichung Hsien (TW)

Correspondence Address: WEN-SHENG HUANG, 235 CHUNG-HO BOX 8-24, TAIPEI HSIEN, 235, TW

(21) Appl. No.: 10/736,099

(22) Filed: Dec. 16, 2003

(51) Int. Cl. B25C 1/04

(52) U.S. Cl. 227/8; 227/130

(57) ABSTRACT

A safety switch of a screwdriver comprises a trigger pivotally installed on the driver body; a push unit in a receiving space being installed within the trigger. One end of a safety rod is installed at a front end of the driver body; and another end thereof is installed at the trigger. The safety rod is movable for pushing the push unit. The push unit comprises a torsion spring one end of which resists against the buckle for restoring the trigger; an ejecting unit resisting against the buckle one end of which is formed with a bevel for pushing a valve rod of the driver body so as to trigger a screwdriver; and an elastomer one end of which is hooked to the ejecting unit; and another end of which is hooked to the trigger.

### FIELD OF THE INVENTION

The present invention relates to screwdrivers, and particular to a safety switch of a screwdriver which has a sample and easily assembled structure.

### BACKGROUND OF THE INVENTION

Screwdrivers are general tools for the carpenters and currently they become more useful for DIY (do-it-yourself) workers. In the prior art, the main concern in designing screwdrivers is the speed and convenience of the screwdriver, but recently, the safety use of screwdrivers becomes more and more important in design of the screwdrivers.

In one prior art, a slide seat is used to control the movement of a turning unit so as to control the triggering operation of the trigger by a first flange on the turning unit, thereby, a predetermined effect can be acquired. In another prior art, a sliding seat resists against and rotates an elastomer 44 so that a buckling portion will shift a stop to rotate through a predetermined angle and thus the body of the screwdriver will triggering the trigger to have a predetermined effect.

In above said prior arts, there are so many components to make the structure complicate. Thereby, the cost is high and the assembly work is tedious. As a result the yield ratio is low.

### SUMMARY OF THE INVENTION

Accordingly, the primary object of the present invention is to provide a safety switch of a screwdriver having a driver body. The safety switch of a screw comprises a push unit; a trigger pivotally installed on the driver body; a receiving space being installed within the trigger for receiving the push unit; a safety rod; one end of the safety rod being installed at a front end of the driver body; and another end of the safety rod being installed at a front end of the trigger; the safety rod being movable into or out of the trigger for pushing the push unit.

The push unit comprises an torsion spring enclosing a pivotal post; a buckle; one end of the torsion spring resisting against the buckle for returning the trigger; an ejecting unit resisting against the buckle; an end of the ejecting unit being formed with a bevel for pushing a valve rod of the driver body so as to trigger a screwdriver; and an elastomer; one end of the elastomer being hooked to the ejecting unit; and another end of the elastomer being hooked to the trigger.

When the safety rod is pressed; the buckle moves to resist against an upper side ejecting unit; and then when the trigger is pressed, the protrusion of the ejecting unit will move forwards to be buckled into the buckling hole; and the push unit moves to push the valve rod so as to trigger the screwdriver.

The various objects and advantages of the present invention will be more readily understood from the following detailed description when read in conjunction with the appended drawing.

### BRIEF DESCRIPTION OF THE DRAWINGS

FIG. 1 is a structural exploded view about the safety switch of a screwdriver of the present invention.

FIG. 2 is a partial perspective view of the safety switch of a screwdriver of the present invention.

FIGS. 3 to 5 shows the operation of the safety switch of a screwdriver of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

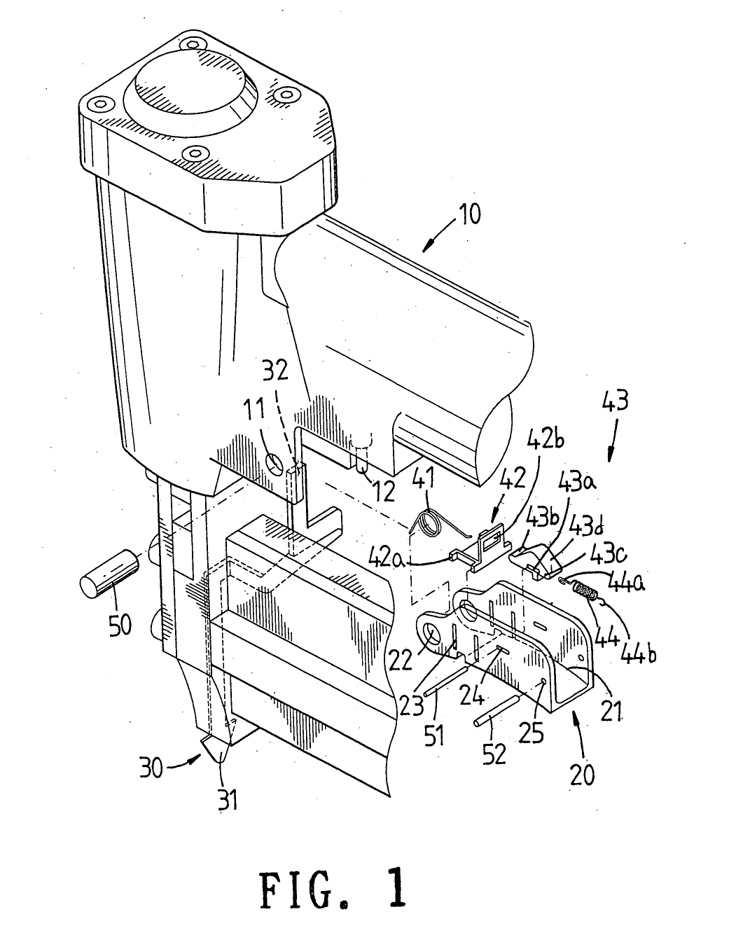

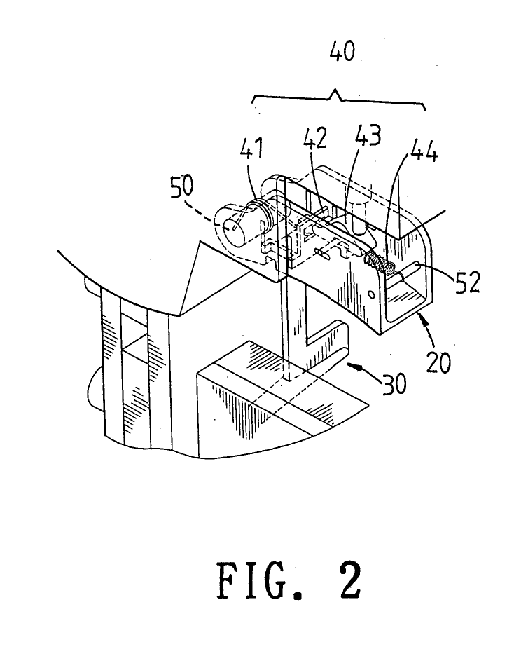

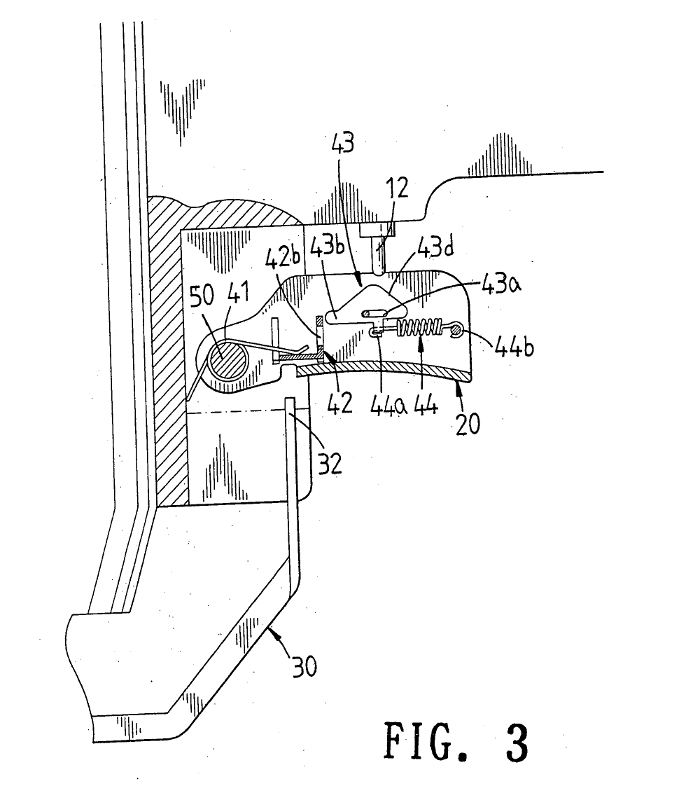

With reference to FIGS. 1 and 3, the safety switch of a screwdriver of the present invention is illustrated. The safety switch includes a driver body 10, a trigger 20, a safety rod 30, and a push unit 40.

The trigger 20 is pivotally installed on the driver body 10. A receiving space 21 is formed within the trigger 20 for receiving the push unit 40. A front end of each of two sides of the trigger 20 has a first pivotal hole 22. A pivotal post 50 passes through a first positioning hole 11 and the first pivotal hole 22 so as to fix the trigger 20 to the driver body 10. A lower predetermined position of the first pivotal hole 22 is formed with two longitudinal slits 23. Furthermore, a slot 24 is formed aside the two slits 23. A through hole 25 is formed aside the slot 24 far away from the slits 23 for positioning a second pin 52.

The safety rod 30 contains a touch end 31 and a push end 32. The touch end 31 is installed at a front end of the driver body 10. The push end 32 is installed in front of the trigger 20. The push end 32 is movable into and out of the trigger 20 for pushing the push unit 40.

The push unit 40 is installed by a torsion spring 41, a buckle 42, an ejecting unit 43, and an elastomer 44. The torsion spring 41 encloses the pivotal post 50. One end of the torsion spring 41 resists against the driver body 10 and another end thereof resists against the buckle 42. By the elastic potential of the torsion spring 41, the torsion spring 41 will push the buckle 42 to return the trigger 20.

Each of the two sides of the buckle 42 is protruded with two blocks 42a for inserting into the slits 23 of the trigger 20. When being pushed by the push end 32 of the safety rod 30, the blocks 42a insert into the slits 23. Moreover, a lateral side of the buckle 42 is formed with a buckling hole 42b for buckling the ejecting unit 43.

The ejecting unit 43 has a trench 43a at a middle portion thereof. A first pin 51 is pivotally installed in the slots 24 of the trigger 20. One end of the ejecting unit 43 is a protrusion 43b for resisting against the buckling hole 42b of the buckle 42. A hook hole 43c is formed at a rear and lower end of the ejecting unit 43 for hooking the ejecting unit 43. Besides, a lateral surface of the ejecting unit 43 is a bevel 43d which resists against a valve rod 12 of the driver body 10 for triggering a nail.

A front end of the ejecting unit 43 has a front hook 44a and a rear end thereof has a rear hook 44b. The front hook 44a hooks hook hole 43c of the ejecting unit 43 and the rear hook 44b hooks the second pin 52.

The structural feature of the present invention is the bevel 43d formed on the ejecting unit 43. When the trigger 20 applies a force to the ejecting unit 43, the bevel 43d of the ejecting unit 43 will generate a horizontal and a vertical force component. When one component is cancelled by the buckle 42, the ejecting unit 43 moves so as to push the valve rod 12 so trigger the screwdriver.

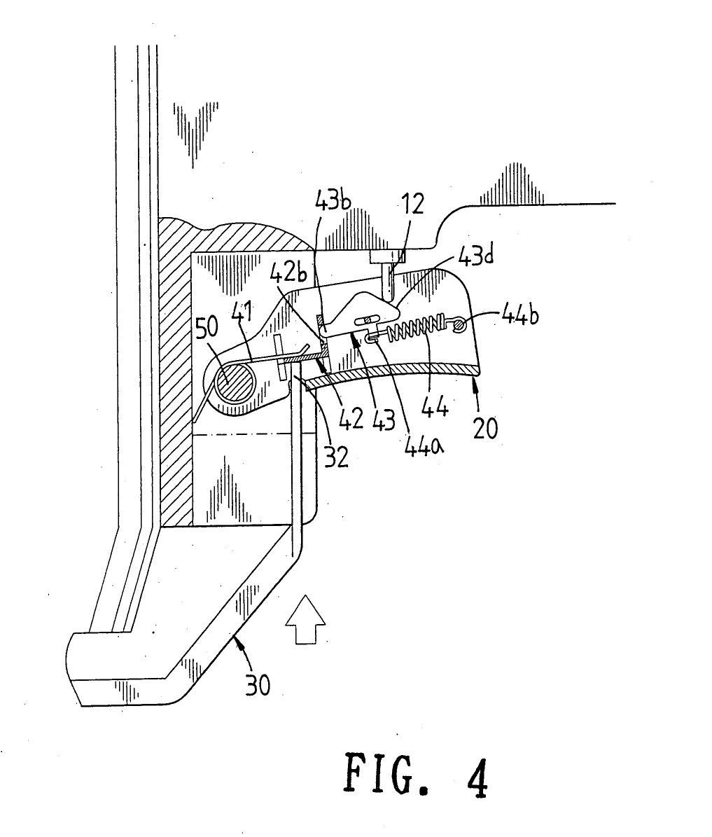

Referring to FIGS. 3 to 5, in operation, generally, the push end 32 of the safety rod 30 is pressed. Then the push end 32 will push the buckle 42 to move to the side of ejecting unit 43. When the trigger 20 is pressed, the protrusion 43b of the ejecting unit 43 will move forwards to be buckled into the buckling hole 42b so that the push unit 40 pushes the valve rod 12 to trigger the screwdriver.

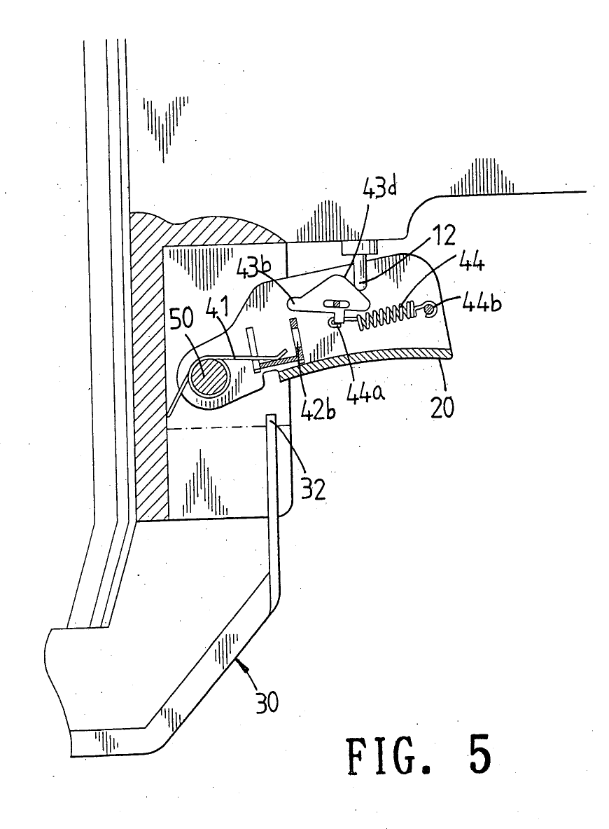

With reference to FIG. 5, if the trigger 20 is pressed firstly, the ejecting unit 43 will move to be at a front side of the valve rod 12 so as not to push the valve rod 12. When the safety rod 30 is pressed again, although the buckle 42 is pushed to move, the valve rod 12 cannot be triggered so as to have a safety effect.

As above mentioned, in the present invention, by the bevel 43d of the ejecting unit 43, and by the simple structure of the ejecting unit 43 and the buckle 42, the present invention can be assembled easily and rapidly. As a result, the cost is reduced and the yield ratio is improved. In the present invention, by the principle of dynamics and elastic potential of the elastomer, the object of safety operation is achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A safety switch of a screwdriver having a driver body; the safety switch of a screw comprising:
a push unit;
a trigger pivotally installed on the driver body; a receiving space being formed within the trigger for receiving the push unit;
a safety rod; one end of the safety rod being installed at a front end of the driver body; and another end of the safety rod being installed at a front end of the trigger; the safety rod being movable into or out of the trigger for pushing the push unit;
wherein the push unit comprises:
a torsion spring enclosing a pivotal post;
a buckle; one end of the torsion spring resisting against the buckle for restoring the trigger to an original position;
an ejecting unit resisting against the buckle; one end of the ejecting unit being formed with a bevel for pushing a valve rod of the driver body so as to trigger the screwdriver; and
an elastomer; one end of the elastomer being hooked to the ejecting unit; and another end of the elastomer being hooked to the trigger;
wherein when the safety rod is pressed downward; then the buckle moves to resist against an upper side ejecting unit; and then when the trigger is pressed, the protrusion of the ejecting unit will move forwards to be buckled into the buckling hole; and the push unit moves to push the valve rod so as to trigger the screwdriver.
